(19) United States
(12) Patent Application Publication
(10) Pub. No.: US 2007/0192323 A1
(43) Pub. Date: Aug. 16, 2007

(54) SYSTEM AND METHOD OF ACCESS AND CONTROL MANAGEMENT BETWEEN MULTIPLE DATABASES

(75) Inventor: LANDON C.G. MILLER, Tuscaloosa, AL (US)

Correspondence Address: GIFFORD, KRASS, SPRINKLE,ANDERSON & CITKOWSKI, P.C, PO BOX 7021, TROY, MI, 48007-7021, US

(73) Assignee: Vertical Systems, Inc., Tuscaloosa, AL (US)

(21) Appl. No.: 11/673,863

(22) Filed: Feb. 12, 2007

Related U.S. Application Data
(60) Provisional application No. 60/772,025, filed on Feb. 10, 2006.

(51) Int. Cl. G06F 17/30

(52) U.S. Cl. 707/9

(57) ABSTRACT

A system and method of automatic access and control management of databases within a system includes a data management computer system and interconnected local computer systems. An accessing system requests information from a target system by data management system. The database management determines whether or not the information request satisfies a predetermined shared information access stored in a lookup table. The data management system verifies the transmitted information by comparing it to the rule and redacts information if necessary and transmits the verified information to the accessing local computer system. The data management system rejects the information access request if determined that the predetermined rule is not satisfied. The data management system determines whether to update the predetermined rule if access is nondeterminable, and automatically updates the rule. The accessing computer system uses the verified information.

### CROSS-REFERENCE TO RELATED APPLICATIONS

This application claims priority of U.S. Provisional Patent Application Ser. No. 60/772,025 filed Feb. 10, 2006 which is incorporated herein by reference.

### BACKGROUND OF THE INVENTION

I. Field of the Invention

The present invention relates generally to database management, and more particularly to a system and method of automatic access and control management between multiple databases.

II. Description of the Prior Art

Project management involves the management of various tasks to accomplish a particular goal. Further, the project may be further divided into subprojects that involve multiple hierarchically arranged groups within the one organization, or across organizations, that cooperatively work together for a specific project. These groups may share information electronically during execution of the task or project. However, it may not be desirable for each organization, group, or individual group member to have unlimited access to each other's information.

Project management relies on information technology to monitor the flow of electronic information pertaining to the project. Information technology generally involves the use of computers and related software to handle information in an electronic format. More specifically, information technology involves activities such as the conversion, storage, protection, processing, transmission or retrieval of electronic information. These tasks are accomplished through the use of a system of interconnected databases.

A database system typically includes a processor or processors for storing and retrieving the information. In addition, the database system utilizes executable software which gathers information to be transmitted to the database or from the database. There are a number of available centralized database systems known as DBMS, or data based management systems, which act as the collector of the data. Various software programs are available to collect the data and then direct the database to take a particular action with the data. An example of a common command language and DBMS combination is CQL, another is structured query language DBMSs. Other types of database systems provide for partial or complete replication of information across the internet or other communications networks. These systems create exact copies of the data, in order to maintain uniformity of data across these databases. In addition, DBMSs have been developed for data or object storing and retrieving using these similar principles.

A database system may involve a single organizational entity, whereby information from the database system is only available to those within the organization. In another example, the database system is accessible by multiple organizational entities, whereby information in the database is selectively available to users, regardless of their organizational affiliation. However, it is recognized that certain information stored in the database may be confidential to a particular user. It is also recognized that organizations that work together may not want to share or commingle data. Therefore, it may be desirable to control access to such information. Various strategies are used to control access. For example, information in the document may be redacted, and the redacted document is made available. The database may prevent access or selectively allow access to the database. At the same time, the user may want to access the information in real time; therefore, an individual database may have controls that screen real-time access to information within a particular database.

While these types of systems work well, they are not as effective in managing the shared use of information across dynamic organizational entities in real time. In addition, they are costly to maintain in terms of overhead and manpower, since they evaluate each information request on an individual basis. Thus, there is a need in the art for a system and method of real-time, automatic management of information transfer between computer databases within a communications network using an externally managed central database.

### SUMMARY OF THE INVENTION

A system and method of automatic access and control management of databases within a system that includes a data management computer system and interconnected local computer systems is provided. The system includes a data management computer system having a server and a database associated with the server. The system includes an accessing local computer system having a processor and an associated database, and the local computer system is operatively in communication with the data management computer system via a communications network. The system includes a target local computer system having a processor and an associated database, and the target local computer system is operatively in communication with data management computer system via the communications network. The system further includes an executable access and control database management software program resident on the data management computer system server.

The method requests information from a target local computer system by an accessing local computer system, and the accessing system transmits the information access request to the data management computer system via a communications network. The data management computer system determines whether the information access request from the accessing system satisfies a predetermined rule controlling access to predetermined shared information stored in the target computer system database, or does not satisfy the predetermined rule, or if access is nondeterminable. The predetermined rule is stored in a rules lookup table maintained by a data management computer system database. The data management system receives the requested information transmitted by the target computer system database if the rules are satisfied and verifies the transmitted information by comparing the transmitted information to the predetermined rule and redacting information that does not compare to the rule and then transmitting the verified information to the accessing local computer system. Or, the data management system rejects the information access request if determined that the predetermined rule is not satisfied. Or, the data management system determines whether to update the predetermined rule if access is nondeterminable, and automatically updates the rule if determined to update the predetermined rule. The accessing computer system uses the verified information.

One advantage of the present invention is that a system and method of automatic real-time access and control management between multiple databases is provided. Another advantage of the present invention is that the system and method selectively and securely shares information between databases. Still another advantage of the present invention is that the selective and secure information sharing is provided between different organizational groups. A further advantage of the present invention is that the system and method uses an external database to automatically and efficiently manage the security of the information and transmission of the information between databases, so that associated costs are reduced. Yet a further advantage of the present invention is that the system and method coordinates the secure sharing of information using predetermined, agreed upon, rules. Still a further advantage of the present invention is that the rules can be updated on a real-time basis by a central database.

Other features and advantages of the present invention will be readily understood as the same become better understood after reading the subsequent description when considered in connection with the accompanying drawings.

### BRIEF DESCRIPTION OF THE DRAWINGS

FIG. 1 is a diagrammatic view illustrating a system of access and control database management between organizations, according to the present invention.

FIG. 2 is a flowchart illustrating a method of access and control database management between organizations using the system of FIG. 1, according to the present invention.

FIG. 3 is a diagrammatic view illustrating a rules table for use by the method of FIG. 2, according to the present invention.

FIG. 4 is a diagrammatic view illustrating an information table for use by the method of FIG. 2, according to the present invention.

FIG. 5 is a flowchart illustrating a method of project management using the system of FIG. 1 and method of FIG. 2, according to the present invention,

### DETAILED DESCRIPTION OF THE PREFERRED EMBODIMENTS

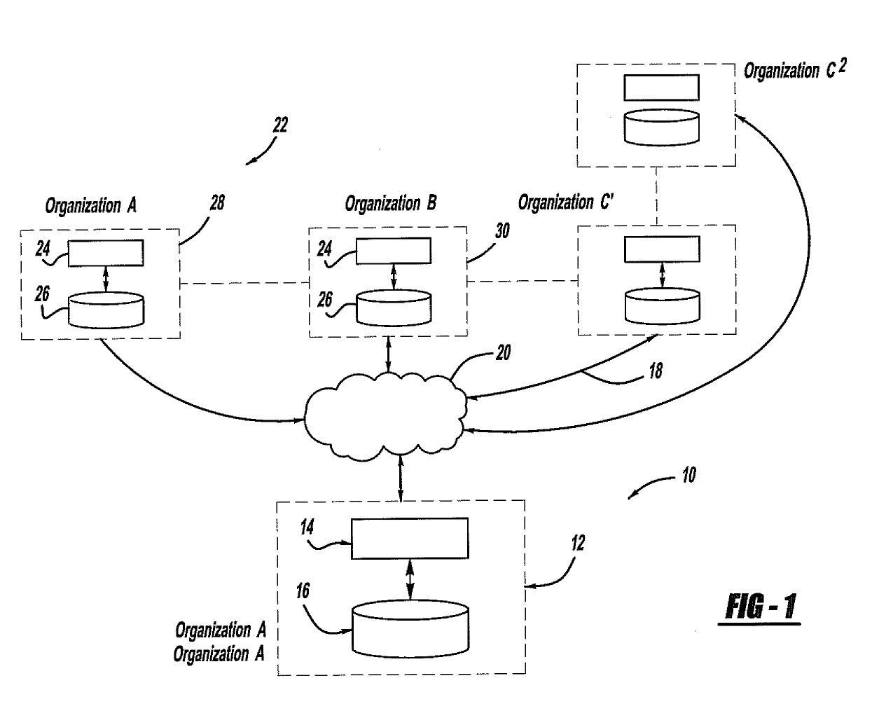

Referring to FIGS. 1-5, a system and method of automatic access and control management between databases is provided. The system and method advantageously coordinates the secure sharing of information using agreed upon, predetermined control rules that can be modified in real time. The system protects the privacy of information maintained in a database, and can automatically modify the amount of information transferred between a target database and an accessing database based on the access and control rules.

The system 10 includes an access and control data management computer system 12. The data management computer system 12 includes a server 14 that manages the communications between local computer systems over a communications network in a manner to be described. In particular, the data management computer system 12 facilitates the transfer of information between these various local systems. It should be appreciated that the information maintained by a particular local system may be stored in a dedicated database for the local system, and the local system is in communication with the central database 16.

The data management computer system 12 includes a server 14, and a central database 16 associated with the server 14. The data management computer system 12 oversees the transfer of information within the system 10. For example, the data management computer system administers the transfer of information within the system 10 in real time, to ensure the security of the transferred information using predetermined rules. It maintains an audit trail of the transferred information. The data management computer system 10 can modify the rules database in real time. It also ensures that the transferring information meets the rules.

The server 14 can use the information stored in the central database 16 for other purposes relative to the project, such as data analysis. In addition, the central processor can direct access to information by the various local systems, using predetermined criteria for shared information.

The central database 16 maintains the rules used to administer access to information in a target database and control of transferred information from the target database. The rules are used to determine who has access to what data, when and why. The rules ensure that the information provided is agreed upon shared information, and non-agreed upon information is not shared. Various strategies may be utilized to maintain the rules. For example, the rules may be maintained in a rules table that delineates conditions for providing access to information in a particular database. It should be appreciated that the rules may be dynamic, and the data management system 12 can update the rules in real time without disrupting other activities in the system 10. The rules may be negotiated between organizations, or within an organization. In addition, the rules are complied with in order for an accessing system to receive information from a target system.

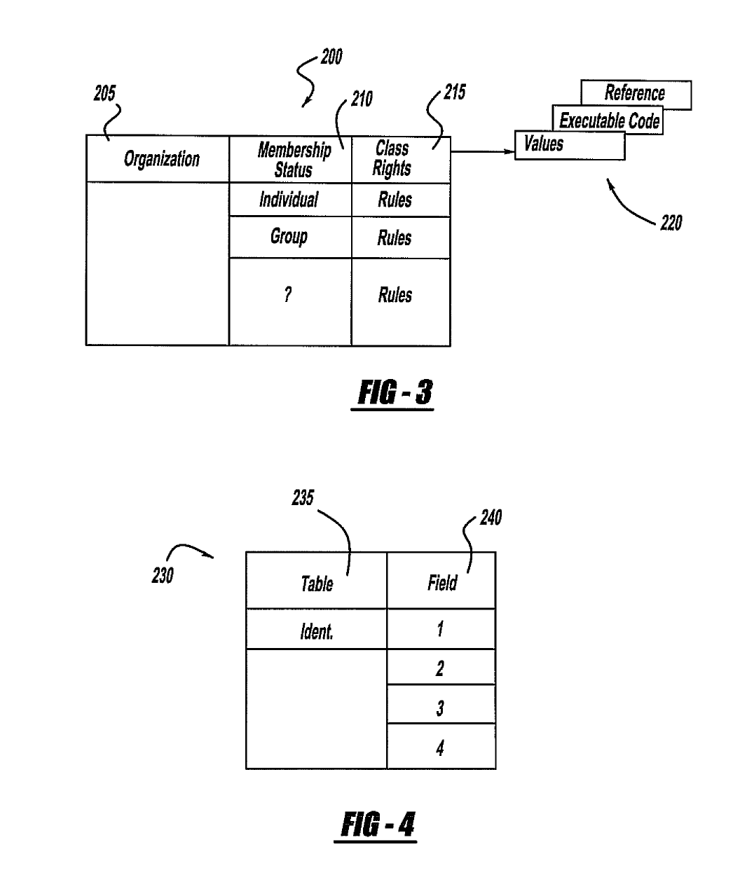

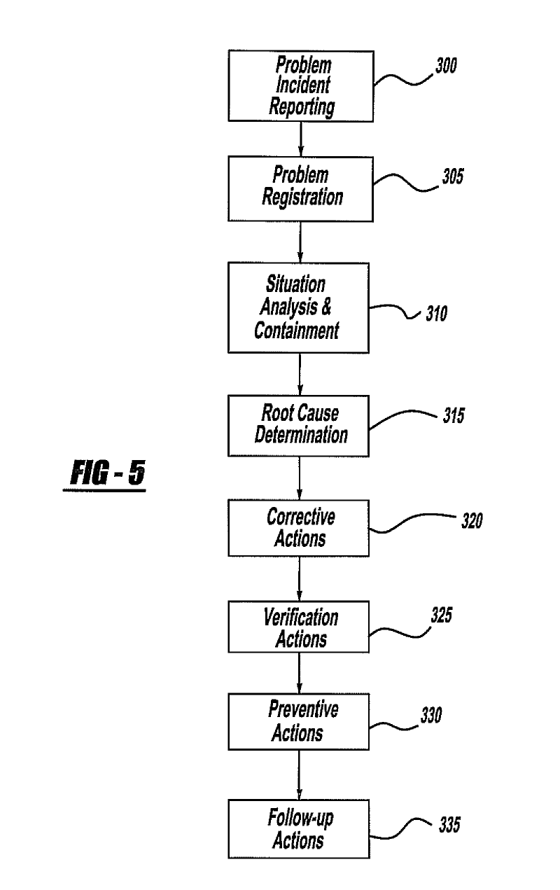

An example of a rules table is illustrated in FIGS. 3 and 4. In this example, the rules table 200 includes various categories, such as organization 205, and an identifying means is established for each organization. The identifying means may be an address, such as the positive Id/IP address or other network address of each of the participating organizations in the system 10.

Another example of a category is membership within the organization 210, and examples of subcategories are a particular group, or individual member of a group, or wild card option. Still another example of a category is a class right 215 for the corresponding membership category. The class right 215 sets forth the particular rules for the corresponding membership subcategory. A rule may have a predetermined format. An example of a rules format is shown in FIG. 4 at 230. In this example, the rule as shown at 235 may be further subdivided using additional criteria as shown at 240. One example of a rule is an “if then” type rule. For example, if group A in organization A requests sales information from organization B, then group A in organization A is provided access to sales information that is stored in organization B's database. Another example of a rule is if group A in organization A requests sales information from organization B, then only provide the director of group A in organization A access to sales information that is stored in organization B's database.

The data management computer system 12 administers the data transfer by receiving a request for information from an accessing organization computer system, such as organization A 22. The data management computer system 12 processes the request in a manner to be described. If access is granted, the data management computer system 12 obtains the requested information from a target organization computer system, such as organization B 28. The data management computer system than compares the transmitted information to the applicable rules. If necessary, the data management computer system 12 redacts information, to satisfy a predetermined rule. The data management computer system 12 transmits the redacted information to the accessing organization computer system. It should be appreciated that the redacted information complies with all the rules controlling the data transfer.

The data management computer system 12 is in communication with other organization's computer systems within the system via a communications network 18. The communications network 18 can be wired or wireless or any combination thereof and is non-limiting. In this example, the communication network 18 is an internet 20, such as the Internet. It may also include an intranet.

The organizations within the system 10 may be integrated horizontally, as shown in FIG. 1 for organization A, organization B and organization C. Further, an organization may be subdivided, as between organization C¹ and organization C². Each organization includes a local computer system having a server or processor, and an associated database. The organization also includes a user having access to the local computer system. The organization may be further subdivided into groups. The group may be vertically integrated with other groups within the organization, or horizontally connected with other organizations. An example of a vertical link is a hierarchical arrangement of departments within an organization. An example of a horizontal link between organizations is that of a supplier, or a customer, or the like.

Each local computer system 22 within an organization A, B, C¹ or C² includes a processor 24 and an associated local database 26. The local computer system 22 communicates with the data management system 12 via the communications network. The organization may assist the data management computer system 12 in maintaining the rules used to determine access to information stored in its database. For example, the local computer system may indicate a particular organization allowed access to predetermined shared information under a predetermined condition, or denied access under other predetermined conditions. Advantageously, shared information may be kept secure and separate from other databases, so that access to confidential information of an organization may be controlled.

An example of a local computer system for an organization is a computing system operating on a server, using a common DBMS, typically of a SQL type, and a master set of processes, implemented within a third instantiation of a DBMS of the same type. Each computer server includes locally controlling software that is in communication with the controlling software maintained by the data management computer system.

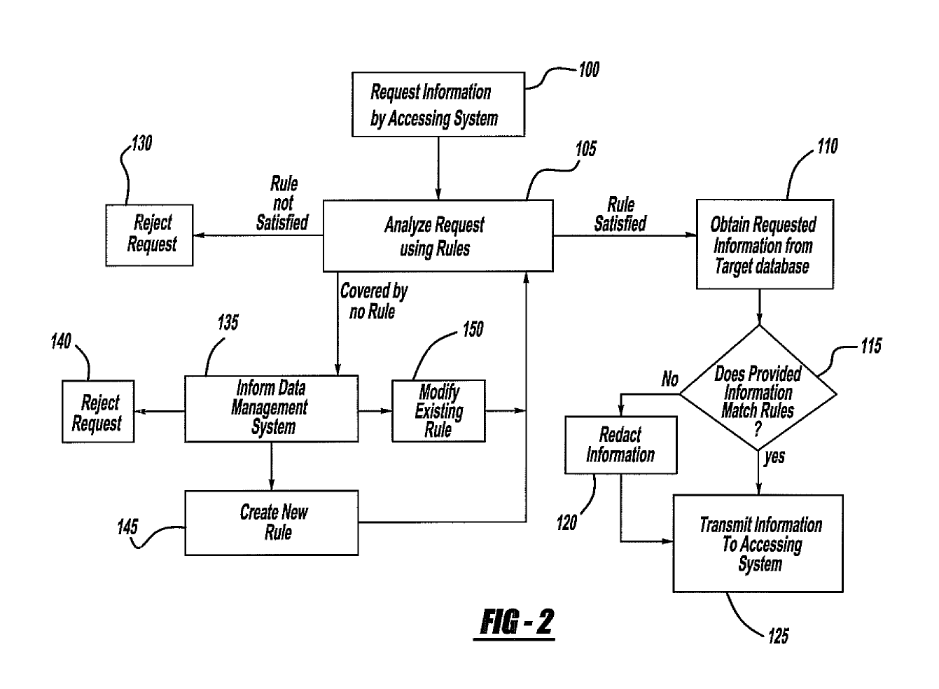

Referring to FIG. 2, a method of automatic access and control management between databases is provided. The method begins in block 100 with a local computer system 22, referred to as the accessing local system 28, requesting access to information from another local computer system in the system 10, referred to as the target local system 30. The accessing local system 28 and target local system 30 may be integrated vertically within a particular organization or horizontally between organizations, as previously described. In this example, the accessing local system 28 and target local system 30 are cooperatively working together on a project. Each local computer system 22 is interconnected with the data management computer system 12 via the communications network 18. The methodology advances to block 105.

In block 105, the data management computer system 12 analyzes the request from the accessing system 28 utilizing a predetermined rules database 16 maintained by the data management computer system. The rules database 16 in this example maintains a rules table 200, which is used to analyze the request. The rules database 16 establishes the predetermined levels of information access for each local system 22. The information access is organized in a predetermined manner. In this example, the information access is organized within a file 230, and the file 23 is stored in a lookup table 200. An advantage of the rules table 200 is that it can be updated in real time, without disrupting operation of the data management computer system 12.

The lookup rules table 205, as previously described, utilizes rules to identify users having access to predetermined information in the database. The rules include parameters such as the identity of the project, specific personnel assigned to the project, available shared information within a database, and specific personnel permitted access to the available shared information. It should be appreciated that for each of the local systems within the network, there can be customizable amounts of information, levels of detail, and subject matter differences identified as redacted or shared. It should be appreciated that any type of rule is feasible within the intent of this invention.

To analyze the request, the data management computer system 12 compares the accessing system information request to the predetermined rules for the accessing system with respect to the requested information contained in the target system 30. As a result of this comparison, the data management computer system 12 determines if the accessing system 22 should be allowed access, should be denied access, or if access is indeterminable, also referred to as a wild card situation. If access is allowed, the methodology advances to block 110, and the data management computer system transmits the request for information to the target system via the communications network. The target system 34 processes the request and obtains the information from the target database 36. The target computer system 30 transmits the requested information to the data management system 12 via the communications network 18.

The methodology advances to block 115 and the data management computer system 12 reviews the transmitted information to determine if the transmitted information correlates with both the rules in the rules table 205, and the request from the accessing system 28. If the transmitted information correlates with the rules, the methodology advances to block 125.

In block 125 the verified information is transmitted to the accessing computer system 28 for use by the accessing user. It should be appreciated that the data management computer system 12 may provide a report to the accessing system 28 or the target system 30. The report may contain information concerning the transaction, such as the access level of the user, whether there were any redactions of information, or the type of information transferred. In addition, a record of information transfer within the system may be maintained by the data management computer system 12. For example, the data management system maintains a log of information shared between local systems via the data management computer system. The data management system 12 may also maintain a log of information it receives from a local system.

Returning to block 115, if the transmitted information does not satisfy the rules, the methodology advances to block 120 and the information is modified or redacted in order to comply with the rules. For example, the data management system 12 may utilize the rules to redact the transferred information so that it complies with the rules. Advantageously, this check of the transmitted information ensures that the right information is transmitted from the target system. The methodology returns to block 125 and the redacted information is transmitted to the user.

Returning to block 105, if access is not determinable using the rules, the methodology advances to block 135. In block 135, the methodology determines whether to update the rules in real time in view of the access request. This determination may be made by a user within the database management system. If determined to create a new rule, the methodology advances to block 145 and a rule is created that addresses the access request and the new rule is added to the rules database 200. The methodology returns to block 105 and continues. If determined that an existing rule should be modified in view of the access request, the methodology advances to block 150 and the existing rule is modified in order to address the access request and the modified rule is added to the rules database 200. An advantage of the present methodology is that the rules database 200 may be modified by an individual in real time. This ensures the efficient access to information during execution of a project. Further, the rules database 200 can be updated on-the-fly, without disruption of the database management computer system or the local systems. The methodology returns to block 105 and continues. If determined that the rules should not be modified or a new rule is not required, the methodology advances to block 140, and the request is denied.

Returning to block 105, if the access request is denied, the methodology advances to block 130 and the data management system 12 notifies the accessing computer system that the information request was denied. This situation may occur in a situation where the requester is not permitted access to that particular information maintained by the target system. It should be appreciated that the data management system 12 may issue a report to the accessing local system 28 or the target local system 30 with details of the transaction, as previously described. The report may contain a message indicating why the access request was denied.

Referring to FIG. 3, a flowchart of a method of program management using the method of FIG. 2 within the system of FIG. 1 is provided. The method of program management is utilized to manage a project designed to solve a problem. The method begins in block 300 with the step of identifying the problem. Problem identification may occur at a global level, or at the local system level. Various strategies are available to identify the problem, such as gathering information regarding the occurrence of an incident, or the like. The methodology described with respect to FIG. 2 is utilized to transfer information as part of the problem identification process.

The methodology advances to block 305, and responsibility for solving the problem is assigned to a predetermined local system 22. Preferably, the system makes the assignments. The methodology advances to block 310.

In block 310, an action plan for analyzing and containing the problem is defined. The action plan may be implemented by the local system alone such as organization A, or in conjunction with other local systems such as organizations B, C¹, C². It should be appreciated that defining the action plan may require the transfer of information within the system using the method of FIG. 2. The action plan may assign responsibility for implementing the analysis and containment plans to the organizations A, B, C¹, C². The methodology advances to block 315.

In block 315, the causation of the problem is determined by the responsible local system. Various strategies are known in the art for determining causation of a problem. Determination of causation may require the transfer of information using the method of FIG. 2.

The methodology advances to block 320, and a corrective action plan is defined and implemented to solve the problem. The corrective plan may include assigning responsibility to an organization A, B, C¹, C² to solve the problem. The methodology advances to block 325.

In block 325, the methodology verifies that corrective actions are in place to solve the problem. For example, the data management system oversees the activities of the local systems or organizations to ensure that corrective actions are being undertaken. The methodology advances to block 330.

In block 330, the methodology identifies strategies for preventing the occurrence of the problem in the future. These strategies could be identified by the data management system, and implemented by the local systems or organizations. It should be appreciated that these strategies could be extended to similar processes within the organization.

The methodology advances to block 335, and the data management system communicates any actions taken to solve the problem, as well as any information learned in the process. The data management system may also continue to monitor the problem such as by auditing the solution. As previously described, any information transfer within the system is accomplished using the method described with respect to FIG. 2.

It should be appreciated that the order of steps is by way of illustration, and that the order may be modified accordingly. The present invention has been described in an illustrative manner. It is to be understood that the terminology which has been used is intended to be in the nature of words of description rather than of limitation.

Many modifications and variations of the present invention are possible in light of the above teachings. Therefore, within the scope of the appended claims, the present invention may be practiced other than as specifically described.

1. A method of automatic access and control management of databases within a system that includes a data management computer system and interconnected local computer systems, the method comprising the steps of:
requesting information from a target local computer system by an accessing local computer system, and the accessing system transmitting the information access request to the data management computer system via a communications network, wherein the accessing computer system is a local computer system that includes a processor and an associated database, and the target computer system is another local computer system that includes a processor and an associated database; and
determining, by the data management computer system, whether the information access request from the accessing system satisfies a predetermined rule controlling access to predetermined shared information stored in the target computer system database, or does not satisfy the predetermined rule, or if access is nondeterminable, wherein the predetermined rule is stored in a rules lookup table stored in a database associated with the data management computer system, and the data management system:
receiving the requested information transmitted by the target computer system database if the rules are satisfied and verifying the transmitted information by comparing the transmitted information to the predetermined rule and redacting information that does not compare to the rule and then transmitting the verified information Lo the accessing local computer system; or
rejecting the information access request if determined that the predetermined rule is not satisfied; or
determining whether to update the predetermined rule if access is nondeterminable, and automatically updating the rule by if determined to update the predetermined rule; and
using the verified information by the accessing computer system.

2. The method as set forth in claim 1, wherein the accessing local computer system and target local computer system are cooperatively working together on a project.

3. The method as set forth in claim 1 wherein the rules table includes predetermined hierarchical rules that identify a predetermined user associated with the accessing local computer system having access to predetermined shared information stored in the target local system database.

4. The method as set forth in claim 1 wherein said step of transmitting the verified information to the accessing local computer system database further includes the step of the data management system supplying the accessing system with a status report concerning the information transfer.

5. The method as set forth in claim 1 wherein said step of determining access further includes the step of updating the rules table in real time by modifying the rule in the rules table, creating a new rule and adding the new rule to the rules table, or deleting the rule from the rules table, and continuing to consider the information request using the updated rules table, by the data management system.

6. A method of automatic access and control management of databases within a system that includes a data management computer system and interconnected local computer systems, the method comprising the steps of:
requesting information from a target local computer system by an accessing local computer system, and the accessing system transmitting the information access request to the data management computer system via a communications network, wherein the accessing computer system is a local computer system that includes a processor and an associated database, and the target computer system is another local computer system that includes a processor and an associated database; and
determining, by the data management computer system, whether the information access request from the accessing system satisfies a predetermined rule controlling access to predetermined shared information stored in the target computer system database, or does not satisfy the predetermined rule, or if access is nondeterminable, wherein the predetermined rule is stored in a rules lookup table stored in a database associated with the data management computer system that includes predetermined hierarchical rules that identify a predetermined user associated with the accessing local computer system having access to predetermined shared information stored in the target local system database, and the data management system:
receiving the requested information transmitted by the target computer system database if the rules are satisfied and verifying the transmitted information by comparing the transmitted information to the predetermined rule and redacting information that does not compare to the rule and then transmitting the verified information to the accessing local computer system; or
rejecting the information access request if determined that the predetermined rule is not satisfied; or
determining whether to update the predetermined rule if access is nondeterminable, and automatically updating the rule by if determined to update the predetermined rule by updating the rules table in real time by modifying the rule in the rules table, or creating a new rule and adding the new rule to the rules table, or deleting the rule from the rules table;
continuing to consider the information request using the updated rules table, by the data management system; and
using the verified information by the accessing computer system.

7. The method as set forth in claim 6, wherein the accessing local computer system and target local computer system are cooperatively working together on a project.

8. The method as set forth in claim 6 wherein said step of transmitting the verified information to the accessing local computer system database further includes the step of the data management system supplying the accessing system with a status report concerning the information transfer.

9. The method as set forth in claim 6 wherein said step of transmitting the verified information to the accessing local computer system database further includes the step of the data management system supplying the target local computer system with a status report concerning the information transfer.

10. A system of database management between groups working on a common project, comprising.
a data management computer system having a server and a database associated with the server;
an accessing local computer system having a processor and an associated database, wherein said local computer system is operatively in communication with data management computer system via a communications network;
a target local computer system having a processor and an associated database, wherein the target local computer system is operatively in communication with data management computer system via the communications network;
an executable access and control database management software program resident on the data management computer system server that requests information from the target local computer system by the accessing local computer system, and the accessing system transmits the information access request to the data management computer system via the communications network, determines whether the accessing system information access request satisfies a predetermined rule controlling access to predetermined shared information stored in the target computer system database, or does not satisfy the predetermined rule, or if access is nondeterminable, wherein the predetermined rule is maintained in a rules lookup table stored in the data management computer system database, and the data management system receives the requested information transmitted by the target computer system database if the rules are satisfied and verifies the transmitted information by comparing the transmitted information to the predetermined rule and redacting information that does not compare to the rule and then transmits the verified information to the accessing local computer system, or rejects the information access request if determined that the predetermined rule is not satisfied, or determines whether to update the predetermined rule if access is nondeterminable, and automatically updates the rule by if determined to update the predetermined rule so that the verified information can be used by the accessing local computer system.

11. The system as set forth in claim 10 wherein the rules table includes predetermined hierarchical rules that identify a predetermined user associated with the accessing local computer system having access to predetermined shared information stored in the target local system database.

12. The system as set forth in claim 10 wherein the data management system supplies the accessing system with a status report concerning the information transfer.

13. The system as set forth in claim 10 wherein the data management system supplies the target local computer system with a status report concerning the information transfer.

14. The system as set forth in claim 1 wherein the data management computer system automatically updates the rules table in real time by modifying the rule in the rules table, creating a new rule and adding the new rule to the rules table, or deleting the rule from the rules table.
